(19) United States
(12) Patent Application Publication
(10) Pub. No.: US 2015/0149925 A1
(43) Pub. Date: May 28, 2015

(54) EMOTICON GENERATION USING USER IMAGES AND GESTURES

(71) Applicant: Lenovo (Singapore) Pte. Ltd., Singapore (SG)

(72) Inventors: Arnold S. Weksler, Raleigh, NC (US); Russell Speight VanBlon, Raleigh, NC (US); John Carl Mese, Cary, NC (US); Nathan J. Peterson, Durham, NC (US)

(73) Assignee: Lenovo (Singapore) Pte. Ltd., Singapore (SG)

(21) Appl. No.: 14/090,010

(22) Filed: Nov. 26, 2013

(51) Int. Cl. H04L 12/58

(52) U.S. Cl. CPC H04L 51/046
USPC 715/752

(57) ABSTRACT

An embodiment provides a method, including: detecting, at an information handling device, a trigger event for insertion of an emoticon into a messaging application; providing, using a processor of the information handling device, an emoticon derived from one or more of an image of a user and a gesture of a user; after the trigger has been detected, inserting, using the processor, the emoticon into the text portion of the chat application. Other aspects are described and claimed.

### BACKGROUND

Information handling devices (“devices”), for example laptop computers, tablets, smart phones, desktop computers, etc., may be used by device users to communicate with one another. A common form of communication is text based communication, e.g., chats communicated via Internet connected applications, SMS text message exchange, email exchange, and the like. Users often wish to supplement the text with other features, e.g., emoticons.

Typically emoticons are formed via a user inputting key inputs, e.g., “:-)”, which represent an emotion and may be mapped and thus converted to another form automatically, e.g., “ [symbol] ”. Additionally, users may selected from a menu of emoticons, e.g., as provided as an add-on in a chat program.

### BRIEF SUMMARY

In summary, one aspect provides a method, comprising: detecting, at an information handling device, a trigger event for insertion of an emoticon into a messaging application; providing, using a processor of the information handling device, an emoticon derived from one or more of an image of a user and a gesture of a user; after the trigger has been detected, inserting, using the processor, the emoticon into the text portion of the chat application.

Another aspect provides an information handling device, comprising: a display device; a processor; and a memory device storing instructions executable by the processor to: detect a trigger event for insertion of an emoticon into a messaging application; provide an emoticon derived from one or more of an image of a user and a gesture of a user; after the trigger has been detected, insert the emoticon into the text portion of the chat application.

Another aspect provides a product, comprising: a computer readable storage device having computer readable program code stored therewith, the computer readable program code comprising: computer readable program code configured to detect, at an information handling device, a trigger event for insertion of an emoticon into a messaging application; computer readable program code configured to provide, using a processor of the information handling device, an emoticon derived from one or more of an image of a user and a gesture of a user; computer readable program code configured to, after the trigger has been detected, insert, using the processor, the emoticon into the text portion of the chat application.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of an information handling device.

FIG. 3 illustrates an example method of providing an emoticon using a user image/gesture.

FIG. 4 illustrates an example method of generating an emoticon derived from a user image/gesture.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Conventionally emoticons for use in chat applications or programs are formed via recognizing a key input pattern and/or via user selection from a menu of stock emoticons. However, if a user needs to provide a predetermined key input pattern, this requires the user to know what the predetermined pattern is. Also, if the user must select from a menu of emoticons, often times these menus contain so many emoticons that it can be cumbersome for the user to select the emoticon the user actually wants, even if it is included in the menu.

Accordingly, an embodiment provides an emoticon that is derived from an image of the user and/or a gesture of the user. For example, an embodiment may operate an optical sensor such as a camera to determine that a user is smiling or providing a specific gesture. If the user thereafter wishes to insert a smiley face emoticon, e.g., as would normally be produced by the key input pattern “:”, “-”, and “)”, and possibly converted by the chat application to “ [symbol] ”, an embodiment may automatically provide this emoticon based on image analysis, i.e., a determination based on the user image that the user in the image is smiling.

Thus, an embodiment leverages image and/or gesture analysis, e.g., to derive an emotion from the image information or otherwise determine an appropriate emoticon, and thereafter offers emoticon(s), e.g., as suggestions, for the user in-line, i.e., while in the chat program. Therefore, a user need not learn predetermined key input patterns and moreover will not have to resort to browsing an extensive menu of possible emoticons, many of which will not match the user's current emotion.

The illustrated example embodiments will be best understood by reference to the figures. The following description is intended only by way of example, and simply illustrates certain example embodiments.

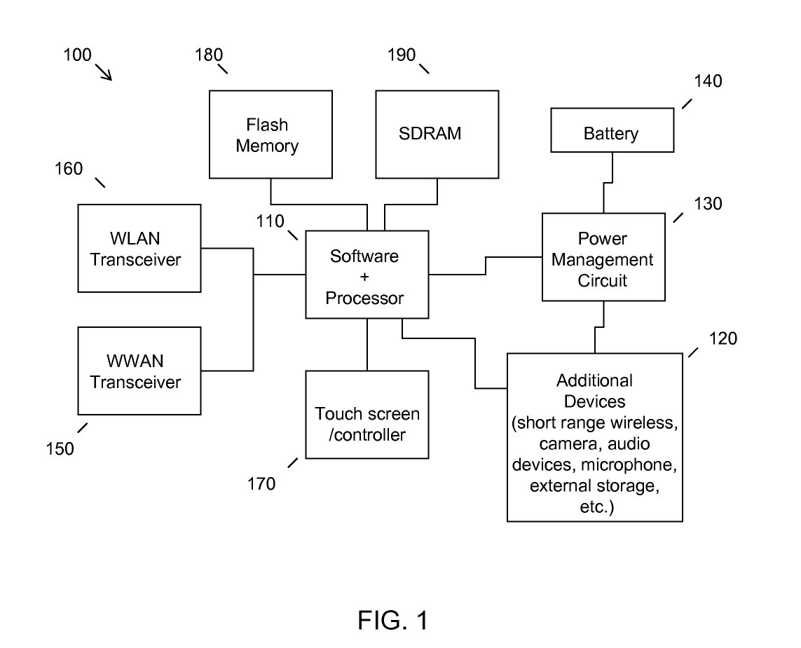

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, one of the additional devices 120 is commonly a camera, which may include two or more cameras (e.g., forward and backward looking cameras). Commonly, system 100 will include a touch screen 170 for data input and display/rendering. System 100 also typically includes various memory devices, for example flash memory 180 and SDRAM 190.

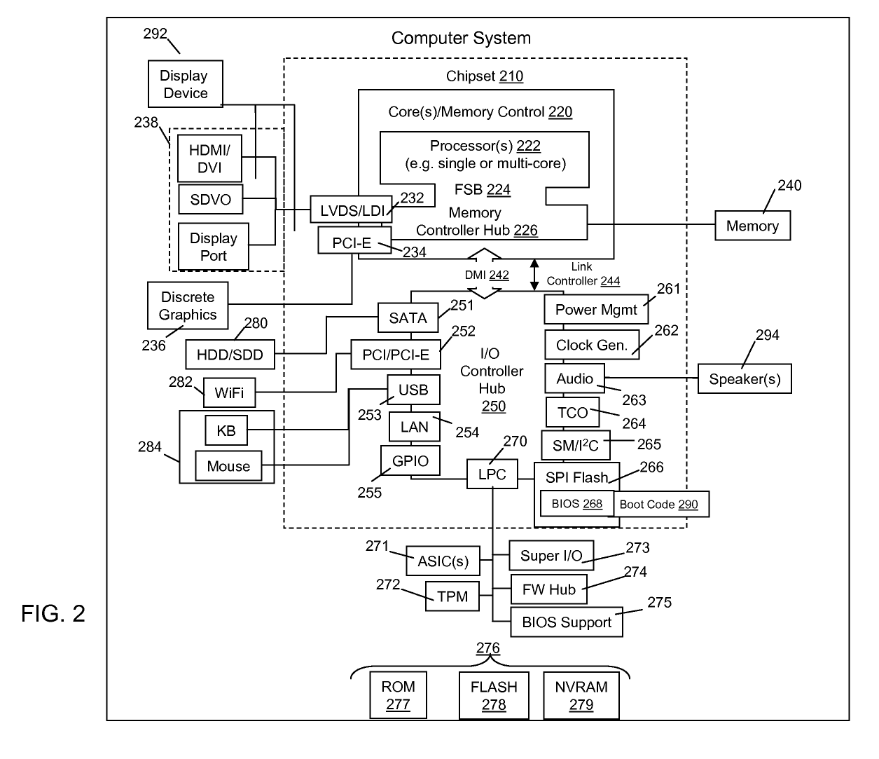

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a LVDS interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices that allow users to communicate with one another via chat applications or programs. A message application or program is defined herein as any communication application that permits users to exchange information in text format. Examples of message (or “messaging” or “chat”) applications or programs include but are not limited to instant messaging applications that communicate text and graphics over the Internet, SMS-text applications that communicate text and graphics using a wide area network, email applications that communicate text and graphics over the Internet, social media applications, etc.

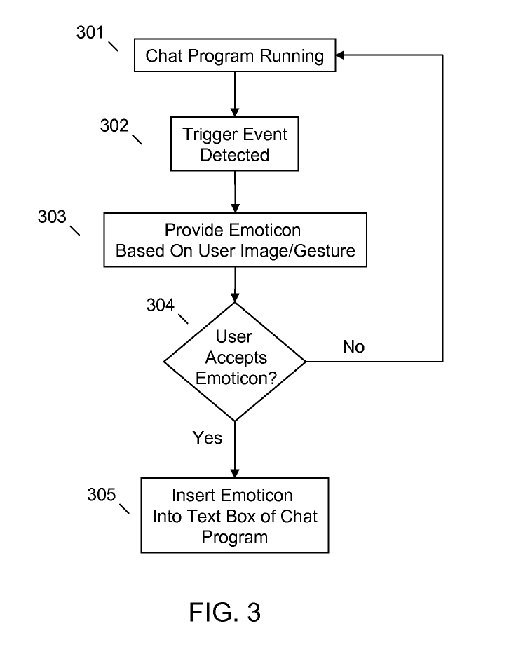

An embodiment permits a user communicating with another user via such a chat application to have emoticons generated, e.g., using image information. For example, referring to FIG. 3, while a chat program is running at 301, a trigger event for entry of an emoticon may be detected at 302. There are a variety of trigger events that may be detected and equally there are a variety of mechanisms that may be utilized in detecting the trigger events.

For example, a trigger event may be selected from the group of events consisting of a predefined key input combination, a gesture, and a user input to a graphical user interface. In the case of a predefined key input combination, for example, a trigger event may be the entry of the key input combination or a portion thereof. Thus, if a user begins to type out a stock emoticon, e.g., via entering “:” followed by “-” and/or “)”, an embodiment may utilize one or more of these key inputs as indicative of emoticon entry or triggering. Thus, an embodiment may thereafter generated and/or provide emoticon(s), e.g., of the type and nature described herein, in response to detecting this trigger event. It should be noted that the emoticon(s) provided by an embodiment may be matched to this predetermined key input, e.g., in place of a stock emoticon that would normally be provided (as will become clear from the following description).

As another example, an embodiment may detect a gesture, e.g., that is mapped to an emoticon trigger event. This may be a special gesture that is predetermined. Thus, using an optical sensor, e.g., camera, or using another gesture sensing technique, e.g., multi-touch sensing, an embodiment may detect a predetermined gesture as a trigger event.

As another example, an embodiment may receive specific or explicit input, e.g., via a graphical user interface provided to the user, that the user is triggering the providing of an emoticon. Thus, a user may instruct the chat application or program, e.g., via selection within an interface or by providing another predetermined key input or key combination input (e.g., not mapped to a stock emoticon), that the user wants an emoticon provided.

In response to the trigger event, e.g., as detected at 302, an embodiment may provide an emoticon to the user at 303. This providing may take a variety of forms. For example, an embodiment may automatically insert the emoticon into the chat application or program, e.g., into the text entry field of the program. Alternatively, an embodiment may first suggest one or more emoticons prior to entry thereof into the chat text entry field. In this example, an embodiment may await a user acceptance of the emoticon suggestion 304.

After the emoticon has been provided, e.g., as a suggestion, an embodiment may thereafter insert the emoticon into the text entry field or box of the chat program such that the user may send the emoticon in a communication to another user, e.g., as an instant message, an SMS-text, an email, etc.

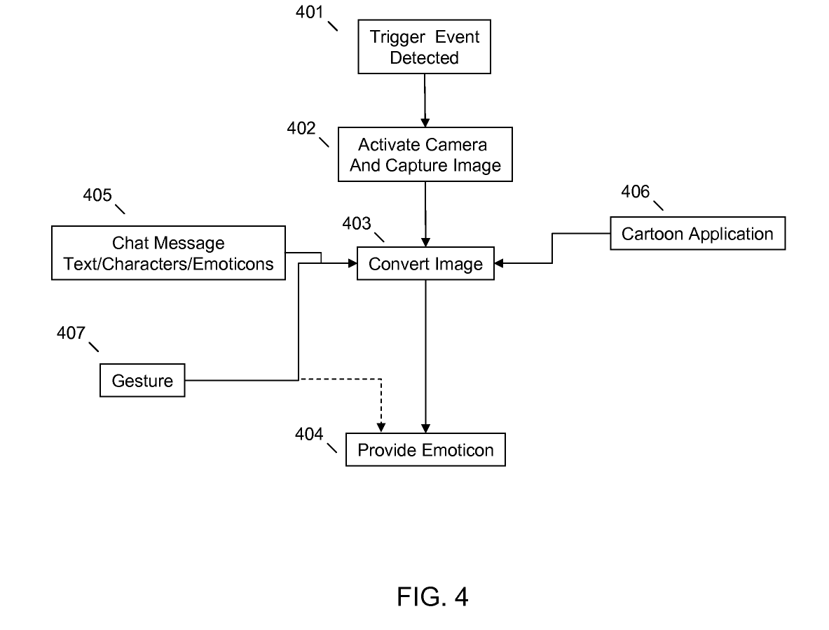

With respect to how the emoticon is provided, an embodiment may utilize image information of the user. For example, referring to FIG. 4, an embodiment may detect a trigger event at 401, e.g., of the nature and type described above. After the trigger event, an embodiment may activate an optical sensor, e.g., standard camera, to capture an image at 402. It should be noted that other mechanisms for obtaining image information are possible. For example, an embodiment may continually or periodically capture images of the user prior to the trigger event, using an image or images responsive to the trigger event. Additionally or in the alternative, a user may create various emoticons using the camera for later use, etc.

Thus it is worth noting at this point that although a particular ordering of events is laid out in the illustrations of the figures, these are simply non-limiting examples and the ordering of events may be changed and/or modified, as well as having certain events consolidated into single vents, expanded into multiple steps, omitted entirely, etc., depending on the circumstance.

In any event, an embodiment accesses user image(s), e.g., at 402, from which emoticons may be derived, e.g., based on a mapping of the emotion of the user in the image and/or based more directly on the image information, as further described herein. Thus, an embodiment may convert the image to an emoticon, e.g., at 403.

For example, an embodiment may analyze the image of the user to determine (e.g., map image information to) an emotion. Thus, if the user in the image is smiling, an embodiment may map this to a smiling emotion and convert the image into a stock smiling emoticon for the user, which may be thereafter provided at 404. In this regard, the analysis or mapping to predetermined emotions may be supplemented given the context in which the image is captured (or otherwise obtained, e.g., from memory if captured earlier).

For example, additional information such as a store of previous chat message text/characters/emoticons 405 of the conversation and/or a store of gesture information 407 (e.g., of the user operating the device) may be utilized to modify the emoticon provided. Thus, if a user's emotion is equally (or nearly so) mapped to two different emotions, underlying context of the conversation (e.g., previous chats, emoticons, etc., either sent or received) may be utilized to assist in the analysis or mapping.

In at least one embodiment, gestures of a user may be used to directly provide an emoticon. For example, whether or not an image has been captured or accessed responsive to a trigger event, if a gesture is detected, e.g., a user holding up two hands to represent a size, an embodiment may directly utilize the gesture to provide the emoticon, with or without underlying context. By way of example, if a user holds up his or her hand in a predetermined way, e.g., thumbs up, this gesture may be directly mapped to a stock emoticon, e.g., a thumbs-up emoticon. As another example, the underlying context (e.g., previous chat text asking the user “how big was the fish you caught?”) may be used in connection with the gesture to modify the emoticon selected, e.g., a fish emoticon may be resized based on the gesture. Moreover, gestures may be used to modify the emoticon derived from an image, such as resizing or warping an image derived emoticon, etc.

Additionally or in the alternative, the image itself may be utilized more directly in forming or generating the emoticon that is provided. For example, other applications, e.g., a cartoon generating application 406, may be activated to convert the image into an emoticon representing the image of the user. Thus, a user may have the image converted into a characterized or cartoon version which is then provided as the emoticon. This may or may not include mapping or analyzing of the user's emotion derived from the image information. That is, the image may be directly converted into a cartoon without analyzing the emotion or the image may be converted into the cartoon form with analysis of the user's emotion, e.g., used to further modify the cartoon form (e.g., exaggerate an emotion identified in the resultant cartoon version of the image).

Accordingly, an embodiment permits a user to provide gestures and images, e.g., as captured in near real time or accessed (e.g., in a store of information previously provided) to assist in the providing of emoticons in chat applications or programs. By virtue of the assisted emoticon generation offered by the embodiments described herein, a user is able to produce more emoticons with less effort as compared to other conventional techniques.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

Any combination of one or more non-signal storage devices may be utilized. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage medium is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a general purpose information handling device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
detecting, at an information handling device, a trigger event for insertion of an emoticon into a messaging application;
providing, using a processor of the information handling device, an emoticon derived from one or more of an image of a user and a gesture of a user;
after the trigger has been detected, inserting, using the processor, the emoticon into the text portion of the chat application.

2. The method 1, further comprising:
capturing, with an optical sensor of the information handling device, an image of the user; and
generating the emoticon using the image captured.

3. The method of claim 2, wherein generating the emoticon using the image of the user comprises converting the image into a cartoon version.

4. The method of claim 1, wherein the trigger event is selected from the group of events consisting of a predefined key input combination, a gesture, and a user input to a graphical user interface.

5. The method of claim 4, wherein the emoticon is matched to at least a portion of the predefined key input combination.

6. The method of claim 5, wherein providing an emoticon comprises providing two or more emoticons comprising a stock emoticon matched to the predefined key input and an image derived emoticon matched to at least a portion of the key input.

7. The method of claim 1, further comprising:
providing an analysis of one or more of a gesture of the user, text input to the chat application by the user and chat messages received by the chat application from another user;
wherein the emoticon is modified based on the analysis.

8. The method of claim 7, wherein the emoticon is modified to match a context derived from the analysis.

9. The method of claim 2, wherein the optical sensor captures the image of the user responsive to the trigger event.

10. The method of claim 9, wherein the emoticon is provided automatically responsive to the trigger event.

11. An information handling device, comprising:
a display device;
a processor; and
a memory device storing instructions executable by the processor to:
detect a trigger event for insertion of an emoticon into a messaging application;
provide an emoticon derived from one or more of an image of a user and a gesture of a user;
after the trigger has been detected, insert the emoticon into the text portion of the chat application.

12. The information handling device 11, wherein the instructions are further executable by the processor to:
capture, with an optical sensor of the information handling device, an image of the user; and
generate the emoticon using the image captured.

13. The information handling device of claim 12, wherein the emoticon generated using the image of the user is generated via converting the image into a cartoon version.

14. The information handling device of claim 11, wherein the trigger event is selected from the group of events consisting of a predefined key input combination, a gesture, and a user input to a graphical user interface.

15. The information handling device of claim 14, wherein the emoticon is matched to at least a portion of the predefined key input combination.

16. The information handling device of claim 15, wherein to provide an emoticon comprises providing two or more emoticons comprising a stock emoticon matched to the predefined key input and an image derived emoticon matched to at least a portion of the key input.

17. The information handling device of claim 1, wherein the instructions are further executable by the processor to:
provide an analysis of one or more of a gesture of the user, text input to the chat application by the user and chat messages received by the chat application from another user;
wherein the emoticon is modified based on the analysis.

18. The information handling device of claim 17, wherein the emoticon is modified to match a context derived from the analysis.

19. The information handling device of claim 12, wherein the optical sensor captures the image of the user responsive to the trigger event.

20. A product, comprising:
a computer readable storage device having computer readable program code stored therewith, the computer readable program code comprising:
computer readable program code configured to detect, at an information handling device, a trigger event for insertion of an emoticon into a messaging application;
computer readable program code configured to provide, using a processor of the information handling device, an emoticon derived from one or more of an image of a user and a gesture of a user;
computer readable program code configured to, after the trigger has been detected, insert, using the processor, the emoticon into the text portion of the chat application.
